(19) United States
(12) Patent Application Publication
(10) Pub. No.: US 2013/0270103 A1
(43) Pub. Date: Oct. 17, 2013

(54) Method Of Enabling And Controlling Ozone Concentration And Flow

(71) Applicants: ShouQian Shao, Fremont, CA (US); Vincent Li, (US); Jason R. Wright, Saratoga, CA (US)

(72) Inventors: ShouQian Shao, Fremont, CA (US); Vincent Li, (US); Jason R. Wright, Saratoga, CA (US)

(73) Assignee: Intermolecular Inc., San Jose, CA (US)

(21) Appl. No.: 13/339,734

(22) Filed: Apr. 17, 2012

(51) Int. Cl. C01B 13/11; B01J 7/00

(52) U.S. Cl. 204/176; 422/186.14

(57) ABSTRACT

Systems and methods to delivery various ozone concentration and various flow rates are disclosed. A low flow, low concentration ozone delivery apparatus comprises an ozone generator configured to deliver a predetermined high flow, low concentration ozone output, an orifice having a predetermined size coupled to the high flow, low concentration ozone output configured to remove a particular amount of the high flow, low concentration ozone, and a mass flow controller coupled to the ozone generator and the orifice, the mass flow controller configured to monitor and control the flow of ozone based on the particular amount bled from the high flow, low concentration ozone to provide a low flow, low concentration ozone.

### FIELD OF THE INVENTION

The present invention relates generally to controlling concentrations and flow rates, and particularly related to controlling the delivery of ozone having a wide range of concentrations and flow rates.

### BACKGROUND OF THE INVENTION

Ozone has been widely used in semiconductor processing. For example, ozone can be used in combination with tetraethyl orthosilicate (TEOS) to deposit silicon dioxide. Ozone can be used in atomic layer deposition (ALD) process to form oxide films, such as aluminum oxide or hafnium oxide. Ozone can also be used for cleaning semiconductor wafers and semiconductor equipment, especially for removing hydrocarbon residues.

Among the methods for producing ozone, corona discharge method is the most common for ozone production. In the corona discharge method, oxygen is passed through the space between two electrodes. When a voltage is applied to the electrodes, a corona discharge is formed between the two electrodes, converting the oxygen in the discharge gap to ozone. In a typical corona discharge phenomenon, oxygen molecules O₂ are split into oxygen atoms O, which then combine with remaining oxygen molecules to form ozone, O₃.

FIGS. 1A-1B illustrate an exemplary ozone generator using corona discharge method. FIG. 1A shows a schematic representation of an ozone generator, comprising electrodes 112 and 114 disposed to form a space 116, which accepts an oxygen, or oxygen-containing, gas 118. When a voltage V is supplied to the electrodes, for example, by applying a positive voltage to electrode 112 and grounding the electrode 114, a corona discharge is formed, and the output flow 119 comprises a mixture of oxygen and ozone.

FIG. 1B shows a block diagram of a commercial ozone delivery system, comprising an ozone generator 130, which accepts an oxygen flow 122. The oxygen flow rate 122 is regulated by a flow controller 120. The ozone generator 130 can also accept a catalyst gas, such as nitrogen 127. The nitrogen 127 flow rate is regulated by a flow controller 125. An ozone monitor 140 is coupled to the output of the ozone generator to measure the amount of ozone generated, such as monitoring the concentration of ozone. In addition, a pressure regulator 150 can be included to regulate the pressure in the ozone generator 130 for optimizing the ozone generating condition. Exhaust conduit 158 or pressure relief path can be included. A system controller 160 can be included to control the ozone delivery system, such as setting the power of the ozone generator 130 to match the flow rates of oxygen and nitrogen according to the ozone amount measure by the ozone monitor, or setting the flow rates of oxygen, nitrogen and ozone concentration to have a auto control to match the required process condition.

There many factors affecting the concentration of the ozone in the oxygen/ozone output mixture. For example, higher voltage can generate more discharge, leading to a higher amount of ozone generated. The corona discharge can generate heat which decomposes ozone, thus coolant circulation around the electrodes can improve the ozone concentration. In addition, resident time of oxygen in the discharge gap is proportional to the ozone concentration, thus a higher oxygen flow can lead to a lower ozone concentration.

In some applications, the availability of ozone concentrations is required from very low (as low as 1 wt %) to high (20 wt %) at different flow rates. There is no ozone delivery system available to meet the ozone concentration requirements across the entire ozone concentration and flow range. Current ozone delivery systems could begin to oscillate at flow rates, for example, below 600 sccm at low ozone concentration. In contrast an ozone delivery system capable of low flow low concentration ozone delivery, for example 1 wt %, 200 sccm, cannot reach high flow, high ozone concentration, for example 20 wt %, 2000 sccm.

Therefore, ozone delivery systems capable of operating at very low to high concentrations of ozone at different flow rates are needed that overcome the shortcomings of current delivery systems.

### SUMMARY OF THE DESCRIPTION

A novel ozone delivery method and system for controlling ozone concentration and ozone flow are disclosed. Currently, standard ozone delivery systems lack the ability to deliver adequate low flow, low concentration ozone that is desired for some ALD applications. Accordingly, a low flow, low concentration capable ozone delivery system comprises an ozone generator configured to deliver a predetermined high flow, low concentration ozone output, together with a divert manifold for reducing the high flow to the desirable low flow condition.

In some embodiments, a method to produce ozone having low concentration and low flow is disclosed, comprising operating an ozone generator at low concentration and high flow conditions, and then reducing the high ozone flow to that of the low flow requirement.

In some embodiments, the present invention discloses an ozone delivery system capable of delivering ozone in multiple conditions, including high concentration with low flow, low concentration with high flow, and low concentration with low flow. The ozone delivery system comprises a high concentration ozone generator meeting the requirements of high concentration with low flow and low concentration with high flow. The ozone delivery system further comprises a flow diversion assembly to reduce the high flow rate to a low flow rate. For example, the flow diversion assembly can comprise an orifice having a predetermined size coupled to the ozone output to divert a particular amount of the ozone output, together with a controller configured to monitor and control the flow of ozone based on the particular amount diverted from the ozone output to provide the desired ozone flow

In some embodiments, the present invention discloses a processing system comprising an ozone delivery system capable of delivering ozone in multiple conditions, including high concentration with high flow, high concentration with low flow, low concentration with high flow, and low concentration with low flow. The flow diversion assembly can be installed in close proximity with a process chamber. The ozone characteristics can thus be monitored, measured or controlled at the point of use, addressing the narrow process windows in advanced applications of both front end of line (FEOL) and back end of line (BEOL), especially in ALD, chemical vapor deposition (CVD) and interface treatment.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIGS. 1A-1B illustrate an exemplary ozone generator using corona discharge method.

FIG. 2A illustrates typical behaviors of ozone concentration as a function of oxygen flow rates.

FIGS. 2B-2D illustrate exemplary behaviors of ozone concentration as a function of oxygen flow rates according to some embodiments of the present invention.

FIGS. 3A-3C illustrate exemplary flow diverter assemblies with fixed orifices according to some embodiments of the present invention.

FIG. 4A illustrates an exemplary flow diverter assembly comprising a flow controller according to some embodiments of the present invention.

FIG. 4B illustrates an exemplary flow diverter assembly comprising a storage chamber according to some embodiments of the present invention.

FIG. 5A illustrates an exemplary flow dilution assembly comprising a flow controller according to some embodiments of the present invention.

FIG. 5B illustrates an exemplary flow diverter and dilution assembly according to some embodiments of the present invention.

FIGS. 6A-6D illustrate exemplary ozone delivery systems according to some embodiments of the present invention.

FIGS. 7A-7B illustrate an exemplary ozone delivery system according to some embodiments of the present invention.

FIGS. 8A-8B illustrate exemplary control systems according to some embodiments of the present invention.

FIGS. 9A-9B illustrate exemplary flow controller systems according to some embodiments of the present invention.

FIG. 10 illustrates an exemplary flowchart for an ozone delivery according to some embodiments of the present invention.

FIG. 11 illustrates another exemplary flowchart for an ozone delivery according to some embodiments of the present invention.

FIG. 12 illustrates an exemplary flowchart for an ozone delivery according to some embodiments of the present invention.

FIG. 13 illustrates an exemplary configuration for a process chamber utilizing an ozone delivery system according to some embodiments of the present invention.

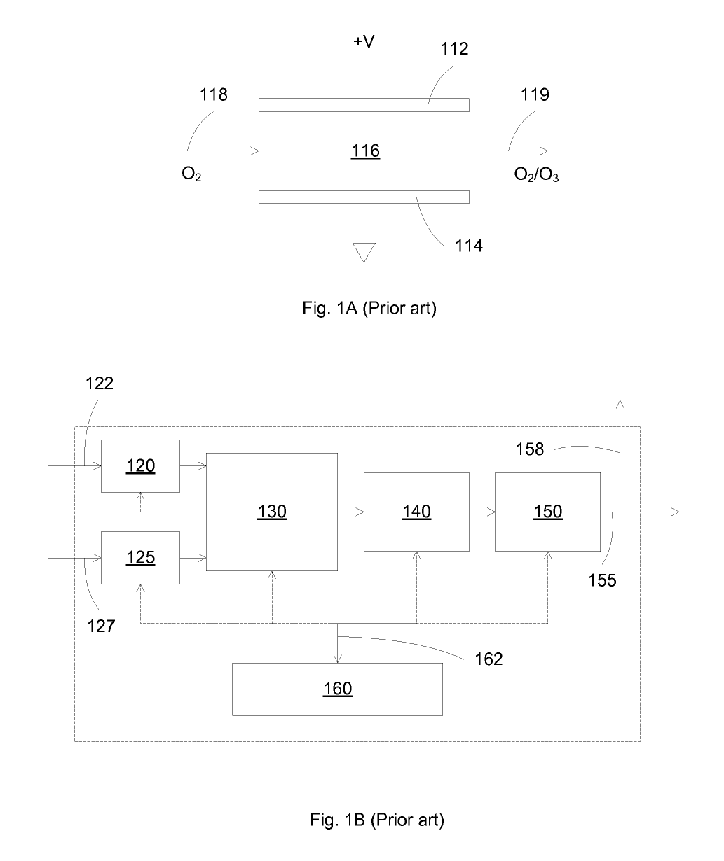

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

In some embodiments, the present invention discloses systems and methods to deliver ozone flow at a wide range of concentration and flow rates. For example, the present ozone delivery system can provide ozone at high concentration with high flow, high concentration with low flow rate, low concentration with high flow rate, and low concentration with low flow rate.

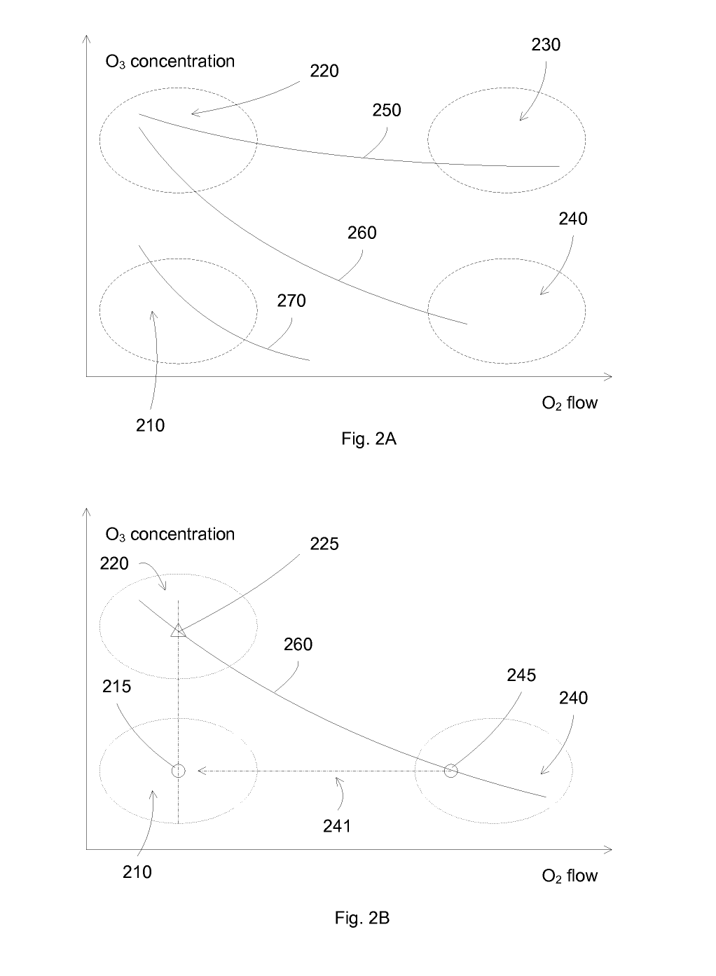

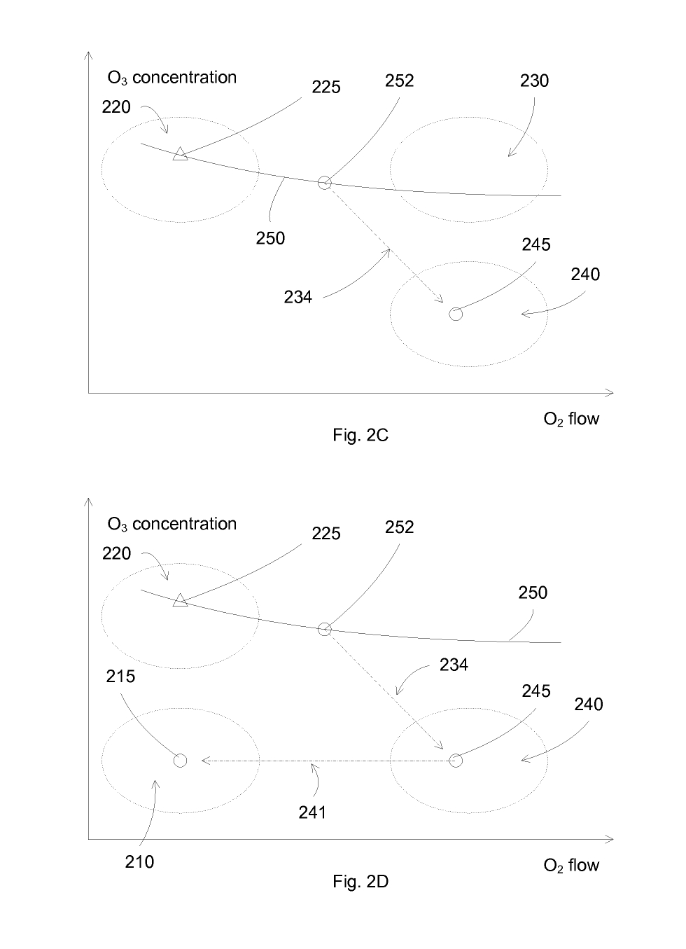

Conventional ozone generators are typically limited to two operating regimes, such as high concentration with low flow rate and low concentration with high flow rate, or high concentration with low flow rate and high concentration with high flow rate. FIG. 2A illustrates typical behaviors of ozone concentration as a function of oxygen flow rates. In general, for corona discharge ozone generators, the concentration of ozone reduces with higher oxygen flow rates due to shorter residence time between the electrodes. The rates of reduction depend on the electrode configuration. For example, an ozone generator with long electrode configurations can have a smaller reduction slope 250 as compared to an ozone generator with shorter electrodes showing a more rapid reduction of ozone concentration 260. Ozone delivery systems thus can have four delivery regimes. Highest ozone concentration regime 220 is at low flow region 220. High ozone concentration with high flow rate can be provided at region 230. In general, the concentration in region 230 is lower than that in region 220. The two regions 220 and 230 can be achieved from a single ozone generator with low concentration loss, such as a generator with long electrode configuration or an ozone generator with multiple electrode sections. Low ozone concentration with high flow rate can be provided at region 240. The two regions 220 and 240 can be achieved from a single ozone generator with high concentration loss, such as a generator with short electrode configuration. Different ozone concentrations at different flow rates can also be achieved by changing power delivered to ozone generator.

Low ozone concentration with low flow rate can be provided at region 210. The region 210 is separate from other regions and typically requires a separate ozone generator (for example, an ozone generator with a short electrode) for generating low ozone concentration. In general, the ozone generators that can produce ozone specifications 270 according to region 210 cannot satisfy the high ozone concentrations of other regions 220, 230 or 240. Thus in general, an ozone generator can cover two or three operation regimes. For example, an ozone generator having concentration/flow characteristics of 250 can provide high ozone concentration at low and high flow rates, e.g., regions 220, 230 and 240. An ozone generator having concentration/flow characteristics of 260 can provide high ozone concentration at low flow rates and low ozone concentration at high flow rates, e.g., regions 220 and 240. An ozone generator having concentration/flow characteristics of 270 can provide low ozone concentration at low flow rates, e.g., region 270.

In the figure, the characteristics of the generated ozone are shown as single curves representing functions of flow and concentration. In practice, different power levels can be used, resulting in regions or curves having finite widths. For example, at a flow value, multiple concentrations can be provided for a single ozone generator, depending on the applied powers. Similarly, at a concentration value, multiple flows can be obtained, depending on the applied powers. Thus. different flows can change the ozone concentration, but different powers are also able to change the ozone concentration at a same flow rate.

In some embodiments, the present invention discloses systems and methods of operating an ozone delivery system capable of operating in more than two regimes, for example, three regions 220, 240, and 210; three regions 220, 230, and 240; or four regions 220, 230, 240, and 210.

FIGS. 2B-2D illustrate exemplary behaviors of ozone concentration as a function of oxygen flow rates according to some embodiments of the present invention. FIG. 2B shows the operation characteristics of an ozone generator having concentration/flow characteristics of 260, which can additionally be operated in region 210. The ozone generator can operate in regions 220 and 240, as exemplified by operating points 225 and 245. The present invention further provides the ozone generator to be operated in region 210. For example, to operate the ozone generator at operating point 215, the corresponding high ozone flow rate can be determined from the characteristic curve 260, showing operation point 245. The ozone generator is then operated at operating point 245, and the output flow is reduced 241 to reach the desired operating point 215. In some embodiments, the flow reduction can be performed by a flow diverter assembly, which diverts an appropriate amount of ozone flow (which is the difference between the flow at operating point 245 and the desired flow at operating point 215).

FIG. 2C shows the operation characteristics of an ozone generator having concentration/flow characteristics of 250, which can additionally be operated in region 240. The ozone generator can operate in regions 220 and 230, as exemplified by operating curve 250. The present invention further provides the ozone generator to be operated in region 240. For example, to operate the ozone generator at operating point 245, the corresponding high ozone concentration can be determined from the characteristic curve 250, showing operation point 252. The ozone generator is then operated at operating point 252, and the output flow is diluted 234 to reach the desired operating point 245. In some embodiments, the flow dilution can be performed by a flow dilution assembly, which provides an appropriate amount of oxygen flow (which is the oxygen flow that can be added to the oxygen/ozone mixture having concentration at 252 to reach the oxygen/ozone mixture having concentration at 245). With the oxygen dilution, the flow rate increases, and thus the corresponding operating point 252 should have a lower flow than the desired operating point 245.

The ozone generator can also be operated in region 210. FIG. 2D shows the operation characteristics of an ozone generator having concentration/flow characteristics of 250, which can additionally be operated in both regions 240 and 210. For example, to operate the ozone generator at operating point 215, the corresponding high ozone concentration can be determined from the characteristic curve 250, showing operation point 252. The ozone generator is then operated at operating point 252, and the output flow is diluted 234 to reach the desired operating point 245, for example, by a flow dilution assembly. The output flow is then reduced 241 to reach the desired operating point 215, for example, by a flow diverter assembly.

In some embodiments, the present invention discloses a flow diverter assembly to achieve a low flow configuration from a high flow operating point. In some embodiments, the present invention discloses a flow dilution assembly to achieve a low concentration configuration from a high concentration operating point. In some embodiments, the present invention discloses a combination of a flow dilution and flow diverter assemblies to achieve a low flow low concentration configuration from a high flow high concentration operating point. For example, the flow dilution assembly can provide a low concentration configuration from a high concentration operating point, but with a high flow. The flow diverter assembly then can provide the low flow configuration from the high flow condition.

In some embodiments, a flow diverter assembly can be operated as a flow dilution assembly. The present invention describes a flow diverter assembly in detail, but a flow dilution assembly can be similarly constructed from the flow diverter assembly. For example, a flow diverter assembly can couple the ozone output flow to an exhaust port for diverting a portion of the ozone output flow. The same flow diverter assembly can also couple the ozone output flow to an oxygen source for adding an oxygen flow to the ozone output flow, resulting in a dilution effect. In addition, a flow diverter can be coupled to a flow dilution to achieve a low flow configuration after obtaining a low concentration configuration.

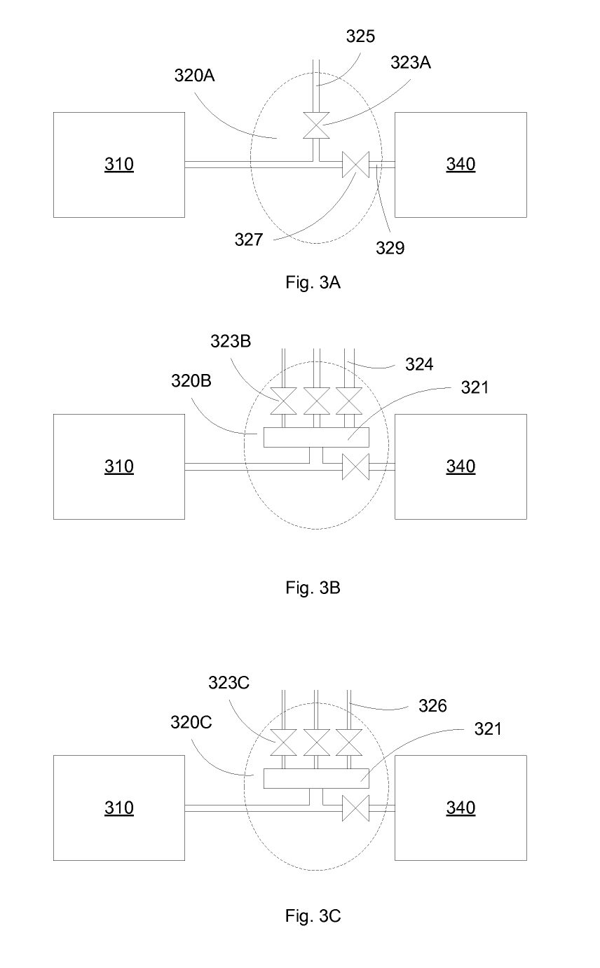

In some embodiments, the present invention discloses flow diverter assemblies comprising conduits having fixed orifices. FIGS. 3A-3C illustrate exemplary flow diverter assemblies with fixed orifices according to some embodiments of the present invention. A flow diverter assembly 320A, 320B, or 320C connects the output of an ozone generator 310 with a process chamber 340. In FIG. 3A, flow diverter assembly 320A comprises a divert conduit 325 having fixed orifice, coupled to a main conduit 329 also having fixed orifice. The amount of flow diverted from the ozone generator is proportional to the percentage of the divert conduit 325. For example, if the two conduits 325 and 329 have same size orifice, then 50% of the flow is diverted, resulting in 50% of the ozone output from the ozone generator reaching the process chamber. Valves 327 and 323A are optional, and can be used to control the flow of the ozone. For example, when valve 323A is close (with valve 327 open), 100% of the ozone output is delivered to the process chamber. When valve 327 is closed (with valve 323A closed), all output is diverted. When both valves are open, 50% of the ozone output is delivered to the chamber. Needle valves can be used to adjust the ratio of the divert flow.

In FIG. 3B, flow diverter assembly 320B comprises multiple conduits 324, each with fixed orifice of different sizes. The different size conduits 324 are connected to a manifold 321 through individual valve 323B. By opening the valves 323B, different amount of flow can be diverted through the flow diverter assembly 320B. The valves can be mutually exclusive, meaning only one valve can be open at a time. Alternatively, multiple valves can be open at a same time. Needle valves can be used to adjust the ratio of the divert flow.

In FIG. 3C, flow diverter assembly 320C comprises multiple conduits 326, each with fixed orifice of same size. The same size conduits 324 are connected to a manifold 321 through individual valve 323C. By opening the valves 323C, different amount of flow can be diverted through the flow diverter assembly 320C. The valves can be mutual exclusive, meaning only one valve can be open at a time. Alternatively, multiple valves can be open at a same time. Needle valves can be used to adjust the ratio of the divert flow.

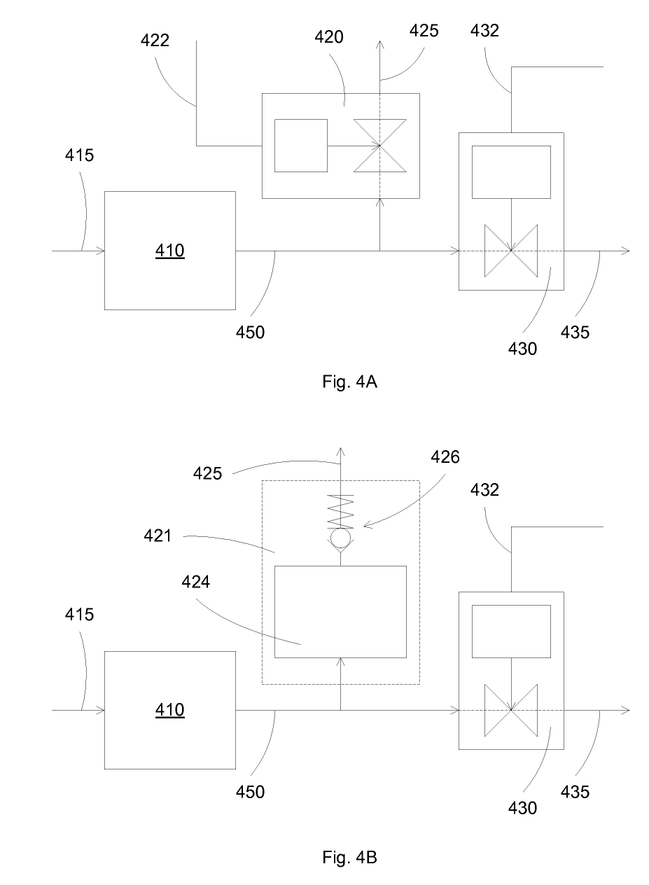

In some embodiments, the present invention discloses flow diverter assemblies comprising controllable exhaust. The flow diverter assemblies can reduce the flow rate generated by the ozone generator so that a desired flow rate can reach a process chamber. FIG. 4A illustrates an exemplary flow diverter assembly comprising a flow controller according to some embodiments of the present invention. An input flow 415 is supplied to an ozone generator 410 to generate an ozone/oxygen mixture output flow 450. A flow controller 430 is fluidly coupled to the output flow 450 to provide a desired flow 435. The flow controller 430 can reduce the flow 450 at the inlet, to produce a flow 435 at the outlet, which is less than the inlet flow 450. The flows 435 and 425 can be controlled by signals 432 and 422, which operate a variable orifice valve in the flow controllers 430 and 420, respectively. In some embodiments, the flow controller 430 comprises a mass flow controller. In some embodiments, a relief valve can be used as of 420 in the line of 425. The rest of the flow can be flowed out through the exhaust line of 425.

In operation, an ozone/oxygen mixture flow 450 with a desirable concentration is provided to the flow controller 430. The flow 450 can have higher flow rate than a desirable flow rate 435, and the flow controller 430 can restrict the flow 450 to achieve the desirable flow rate 435. The remaining flow can be diverted through a flow diverter assembly 420. For example, a control signal can be sent to the ozone generator 410 with the desired concentration and a setting flow rate that is higher than the desired flow rate. In some embodiments, the set flow rate is preferably slightly higher to account for the potential loss through the delivery system and assembly. In some embodiments, the set flow rate is the lowest flow rate that can provide the desired ozone concentration. The flow controller 430 is then set to the desired flow rate, and therefore the output flow 435 have the desired concentration and flow rate. The remaining flow rate, e.g., the difference between the setting flow rate and the desired flow rate, can be diverted through the flow diverter assembly 420. In some embodiments, the flow controller 420 is set to the remaining flow rate.

In some embodiments, the flow controller 430 is optional, and can be omitted. Alternatively, the flow controller 430 can be set to be fully open, allowing all gases to pass through. With the flow diverter assembly set to allow a difference flow between the output flow 450 and the desired flow 435, the flow reaching the process chamber is the desired flow. For example, this configuration can be used when the desired flow 435 is coupled close to the process chamber.

FIG. 4B illustrates an exemplary flow diverter assembly comprising a storage chamber according to some embodiments of the present invention. An input flow 415 is supplied to an ozone generator 410 to generate an ozone/oxygen mixture output flow 450. A flow controller 430 is fluidly coupled to the output flow 450 to provide a desired flow 435. The flow 435 can be controlled by signal 432, which operates a variable orifice valve in the flow controller 430.

A flow diverter assembly 421 is coupled to the ozone/oxygen mixture output flow 450 to release the excess flow rate in 450 that does not pass through the controller 430. Flow diverter assembly 421 comprises a storage chamber 424 to absorb the difference between the output flow 450 and the desired flow 435. A relief valve 426 can be coupled to the storage chamber 424 to release the pressure in the storage chamber. The relief valve can be controlled to be open only when the pressure exceeds a set value. Other flow diverter assemblies can also be used, for example, using a diverter assembly without the flow controller 430.

In operation, an ozone/oxygen mixture flow 450 with a desirable concentration is provided to the flow controller 430. The flow 450 can have higher flow rate than a desirable flow rate 435, and the flow controller 430 can restrict the flow 450 to achieve the desirable flow rate 435. The remaining flow can be diverted through a flow diverter assembly 421 and stored in the storage chamber 421. When the pressure in the storage chamber exceeds a set point, the relief valve 426 is opened to reduce the pressure in the storage chamber.

In some embodiments, the present invention discloses flow dilution assemblies comprising controllable gas supply. The flow dilution assemblies can reduce the concentration (while increase the flow rate) generated by the ozone generator so that a desired concentration can reach a process chamber.

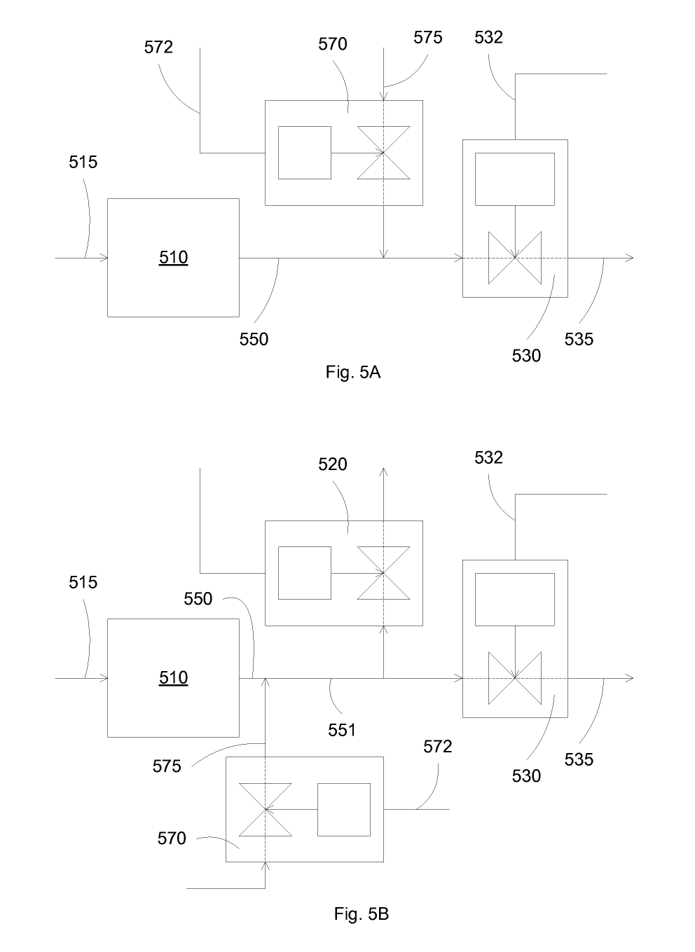

FIG. 5A illustrates an exemplary flow dilution assembly comprising a flow controller according to some embodiments of the present invention. An input flow 515 is supplied to an ozone generator 510 to generate an ozone/oxygen mixture output flow 550. A first flow controller 530 is fluidly coupled to the output flow 550 to provide a desired flow 535. An oxygen supply 575 can be provided through a flow dilution assembly 570 to mix with the output flow 550, essentially reducing the concentration of the output flow 550. The amount of oxygen flow can be controlled, for example, by signal 572, to obtain the desired concentration at the outlet flow 535.

In operation, an ozone/oxygen mixture flow 550 is provided to the flow controller 530. The flow 550 can have higher concentration than a desirable concentration at 535, and the flow dilution assembly 570 can add additional oxygen to the flow 550 to achieve the desirable concentration 535. The resulting flow rate 535 is higher than the flow rate of the output 550. The dilution flow through the dilution assembly 570 can be controlled by signal 572, which together with the flow rate of 550, can be calculated to achieve the desired flow rate for 535.

In some embodiments, the flow controller 530 is optional, and can be omitted. Alternatively, the flow controller 530 can be set to be fully open, allowing all gases to pass through.

FIG. 5B illustrates an exemplary flow diverter and dilution assembly according to some embodiments of the present invention. A flow dilution assembly 570 is provided to reduce the concentration of the output flow 550 from the ozone generator to the desired concentration 551. A flow diverter assembly 520 is provided to reduce the flow rate of the resulting flow 551 to the desired flow rate 535.

In operation, an input flow 515 is supplied to an ozone generator 510. The input flow 515 can comprise oxygen, and some catalyst gas, such as nitrogen, to improve the operation of the ozone generator. An ozone/oxygen mixture flow 550 is output from the ozone generator. The flow 550 can have higher concentration than a desirable concentration at 535, and the flow dilution assembly 570 can add additional oxygen to the flow 550 to achieve the desirable concentration 535. The resulting flow rate 535 is thus higher than the flow rate of the output 550. The amount of the additional oxygen flow 575 is controlled by signal 572, calculated to achieve the desired concentration in the resulting flow 551.

If the resulting flow 551 has higher flow rate than the desired flow rate, a flow diverter assembly 520 is provided to reduce the flow rate of the resulting flow 551. For example, the flow controller 530 is set to the desired flow rate, and therefore the output flow 535 have the desired concentration and flow rate. The remaining flow rate, e.g., the difference between the setting flow rate and the desired flow rate, can be diverted through the flow diverter assembly 520.

In some embodiments, the flow controller 530 is optional, and can be omitted. Alternatively, the flow controller 530 can be set to be fully open, allowing all gases to pass through.

In some embodiments, the present invention discloses a process chamber utilizing the present ozone delivery system. The process chamber can be configured for application using ozone, such as TEOS/Ozone deposition, or ALD processes. Many ALD systems use ozone as an oxidant for film deposition, such as Al₂O₃, HfO₂, ZrO₂, Ta₂O₅ and TiO₂. The ozone generator usually is located far away from the process chamber, and the ozone concentration is measured at ozone generator output. The long delivery line, which can be heated, can affect the ozone concentration, for example, some ozone could be lost before reaching process chamber. Measuring, monitoring or controlling the ozone concentration at a point of use is therefore important for critical process control.

In some embodiments, the present invention discloses hardware and process monitoring, troubleshooting as well as controlling, comprising positioning a portion of the ozone delivery system in a close vicinity of a process chamber, and configuring the system controller to accept the operation of the ozone delivery system.

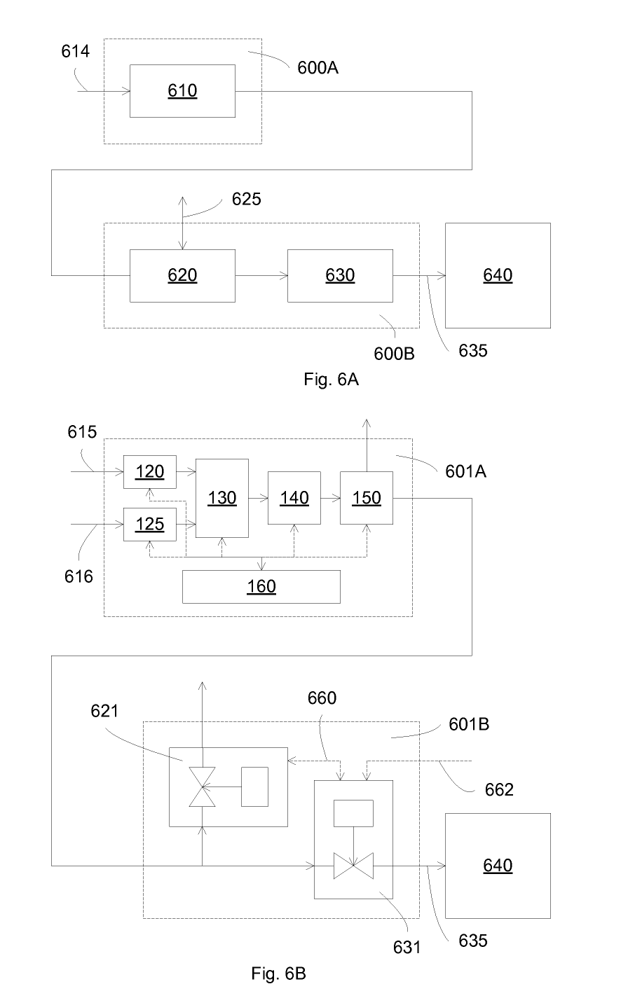

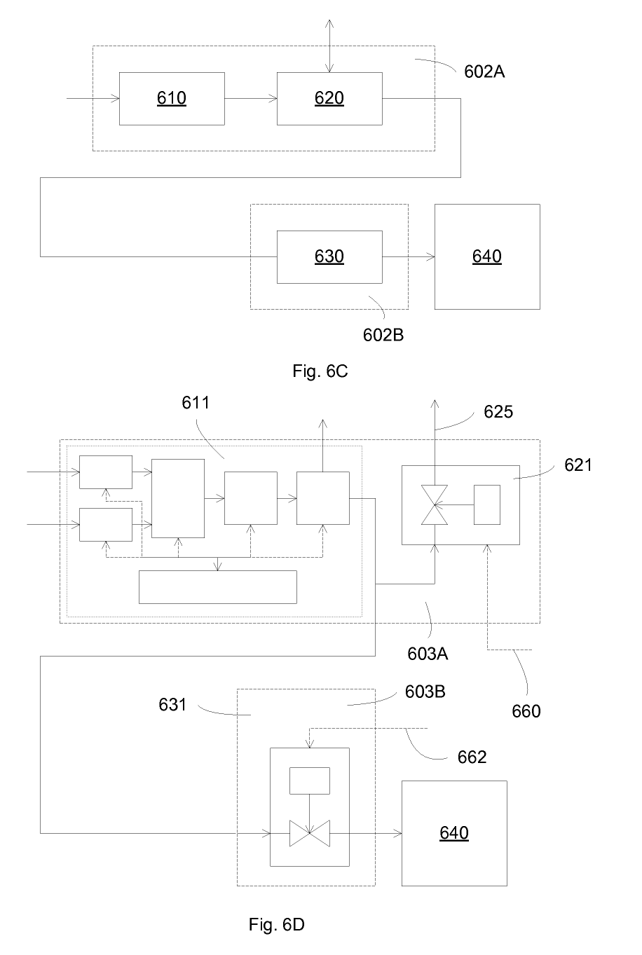

FIGS. 6A-6D illustrate exemplary ozone delivery systems according to some embodiments of the present invention. FIG. 6A shows a block diagram of an ozone delivery system, comprising a first portion 600A coupled to a second portion 600B before delivery to a process chamber 640.

The first portion can comprise an ozone generator 610. The second portion can comprises a flow diverter/dilution assembly 620 coupled to an optional flow controller 630. The second portion is preferably disposed in close proximity to the process chamber 640, while the first portion can be disposed in a farther distance, for example, in a serviceable area.

The ozone generator 610 comprises an input flow 614, which can be an oxygen flow or an oxygen/nitrogen flow mixture. The flow diverter/dilution assembly can be a flow diverter assembly, a flow dilution assembly, or a combination of a flow diverter assembly and a flow dilution assembly. The flow diverter/dilution assembly can comprise outlet/inlet 625 for exhaust/supply. The outlet/inlet 625 can comprise multiple conduits, for example, one for exhaust outlet for a flow diverter assembly and one for oxygen supply inlet for a flow dilution assembly. The resulting flow 635 is achieved by adjusting the output flow from the ozone generator, for example, by reducing the flow rate through the flow diverter assembly and reducing concentration through the flow dilution assembly.

FIG. 6B shows a schematic of the ozone delivery system, comprising a first portion 601A and a second portion 601B. First portion 601A comprises an ozone generator, such as a conventional ozone generator disclosed above, using oxygen input 615 and nitrogen input 616. Second portion 601B comprises a flow diverter assembly 621 coupled to a flow controller 631. Control signal 662 can be used to control the flow controller 631 to a desired set point. Signal 660 can be used to control the flow diverter assembly, for example, generated from the flow controller 631 or from a central controller. Other configurations can also be used, such as a flow diverter assembly 621 without a flow controller 631, a flow dilution assembly, or a combination of flow diverter and dilution assembly.

FIG. 6C shows a block diagram of an ozone delivery system, comprising a first portion 602A coupled to a second portion 602B before outputting to a process chamber 640.

The first portion can comprise an ozone generator 610 and a flow diverter/dilution assembly 620. The second portion can comprise an optional flow controller 630. The second portion is preferably disposed in close proximity to the process chamber 640, while the first portion can be disposed in a farther distance, for example, in a serviceable area.

FIG. 6D shows a schematic of the ozone delivery system, comprising a first portion 603A and a second portion 603B. First portion 603A comprises an ozone generator 611 and a flow diverter assembly 621. Second portion 603B comprises a flow controller 631. Control signal 662 can be used to control the flow controller 631 to a desired set point. Signal 660 can be used to control the flow diverter assembly. Other configurations can also be used.

In some embodiments, the present invention discloses an ozone delivery system that is capable of delivering different ozone concentration at different flow rates. The present ozone delivery system can comprise an ozone generator that can generate ozone at high concentration, and a flow diverter/dilution assembly to reduce the concentration or a flow rate generated from the ozone generator to desired values.

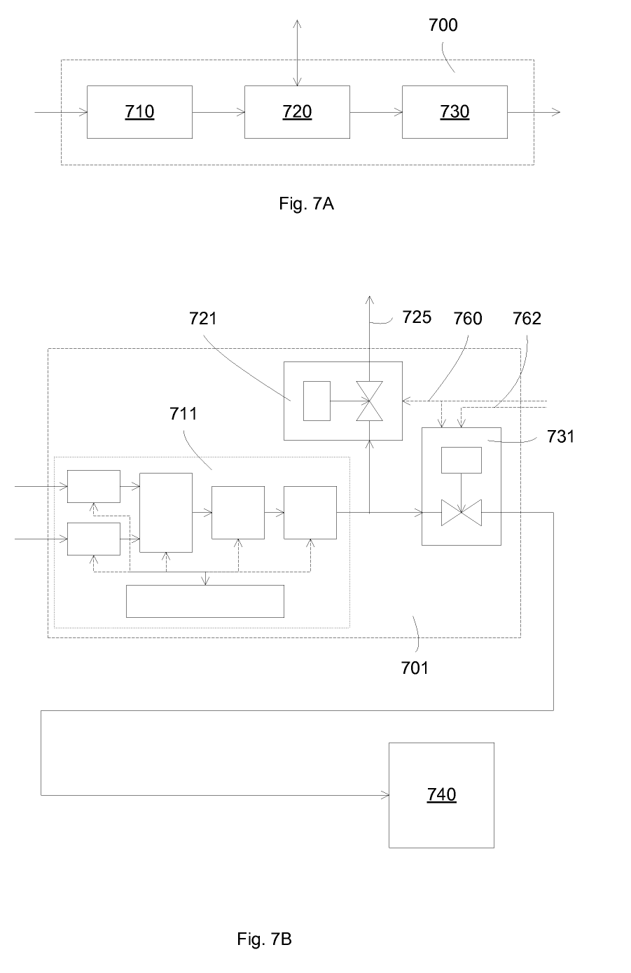

FIGS. 7A-7B illustrate an exemplary ozone delivery system according to some embodiments of the present invention. FIG. 7A shows a block diagram of an ozone delivery system 700, comprising an ozone generator 710 coupled to a flow diverter/dilution assembly 720 coupled to an optional flow controller 730.

FIG. 7B shows a schematic of the ozone delivery system, comprising an ozone delivery system 701 coupled to a process chamber 740. The ozone delivery system 701 comprises an ozone generator 711, a flow diverter assembly 721 coupled to a flow controller 731. Control signals 762 and 760 can be used to control the flow controller 731 and the flow diverter assembly 721 to a desired set point. Other configurations can also be used.

In some embodiments, the present invention discloses an ozone delivery system comprising an ozone generator, wherein the ozone generator comprises a first outlet, wherein the ozone generator is operable to deliver ozone at a first operation condition and a second operation condition, wherein the first operation condition comprises a first ozone concentration and a first ozone flow rate, wherein the second operation condition comprises a second ozone concentration and a second ozone flow rate, wherein the first ozone concentration is higher than the second ozone concentration, wherein the first ozone flow rate is lower than the second ozone flow rate; a flow controller in fluid contact with the first outlet of the ozone generator, wherein the flow controller comprises an inlet for accepting a first flow and a second outlet for outputting a second flow, wherein the inlet is in fluid contact with the first outlet of the ozone generator, wherein the flow controller is operable to control the flow rate of the second flow to be lower than the flow rate of the first flow; and a flow assembly in fluid contact with the first outlet of the ozone generator, wherein the flow assembly comprises a controllable diversion path for accepting the difference between the first flow and the second flow.

In some embodiments, the flow controller comprises a mass flow controller configured for controlling a mixture of oxygen/ozone. The flow controller comprises a mass flow controller configured for controlling an oxygen flow with a conversion factor suitable for the concentration of a mixture of oxygen/ozone. The flow assembly comprises one or more conduits of fixed orifice. The flow assembly comprises a conduit with controllable orifice. The flow assembly comprises a mass flow controller. The flow assembly comprises a storage volume with a relief valve. The first ozone concentration is higher than 15 wt %, and the second ozone concentration is lower than 5 wt %.

The system can further comprise a circuit controller for controlling at least one of the flow controllers, the flow assembly, a power of the ozone generator and an oxygen flow rate of the ozone generator. The system can also comprise a second circuit controller controlling the flow assembly, wherein the second circuit controller controls the flow of the flow assembly with input from the flow controller.

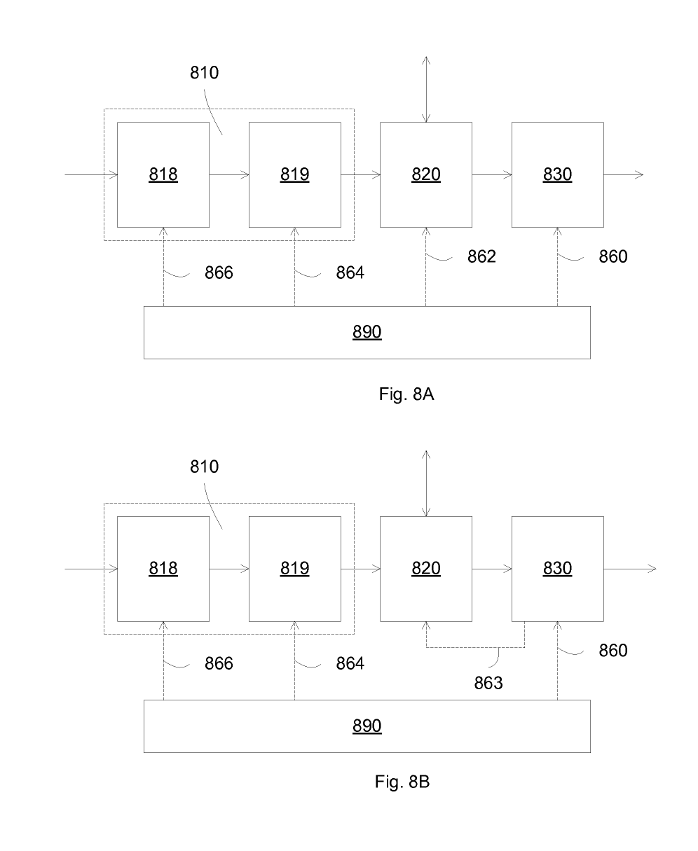

In some embodiments, a circuit controller can be included to control the ozone delivery system. The circuit controller can control the ozone generator the flow diverter/dilution assembly, and the flow controller. FIGS. 8A-8B illustrate exemplary control systems according to some embodiments of the present invention. In FIG. 8A, an ozone generator 810 comprising input controller 818 coupled to an ozone assembly 819 is coupled to a flow diverter/dilution assembly 820, which is coupled to an optional flow controller 830. A circuit controller 890 can be used to control the ozone delivery system, for example, to provide input flow setting 866 to the input controller 818, provide power setting 864 to the ozone assembly 819, provide flow setting 862 to the flow diverter/dilution assembly 820, and provide flow setting 860 to the flow controller 830.

FIG. 8B shows another controlling scheme according to some embodiments of the present invention. Flow setting 863 to the flow diverter/dilution assembly 820 can be provided by the flow controller 830. Alternatively, the flow controller 830 can be omitted, or the flow setting for the flow controller can be supplied by the flow diverter/dilution assembly 820.

In some embodiments, the flow controller or the flow diverter assembly can comprise a mass flow controller, designed for flow setting and measuring. In some embodiments, the mass flow controller can be an ozone/oxygen mixture controller. In some embodiments, the mass flow controller can be an oxygen (or other gases) controller.

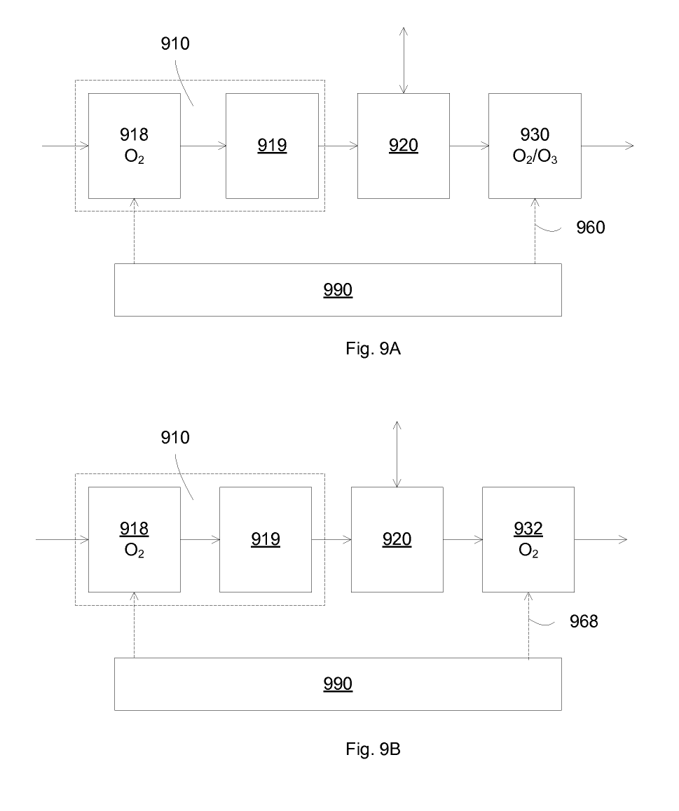

FIGS. 9A-9B illustrate exemplary flow controller systems according to some embodiments of the present invention. In FIG. 9A, an ozone generator 910 comprising input controller 918 coupled to an ozone assembly 919 is coupled to a flow diverter/dilution assembly 920, which is coupled to an optional flow controller 930. A circuit controller 990 can be used to control the ozone delivery system, for example, to provide flow setting 960 to the flow controller 930. The flow controller 930 can comprise an ozone/oxygen mixture controller, with the flow setting 960 being the flow value of the mixture.

In FIG. 9B, a flow controller 932 can comprise an oxygen controller, with the flow setting 968 being the flow value of oxygen, adjusted from the value of the ozone/oxygen mixture. For example, a concentration of the flow through the flow controller 932 is known, and thus the amount of ozone is converted to an equivalent amount of oxygen to obtain an effective oxygen flow to be inputted to the controller 932. The controller 932 can be a mass flow controller calibrated to measure an oxygen flow, and the control signal 968 comprises an effective flow value for the oxygen flow.

In some embodiments, the present ozone delivery system comprises a controller or sensor for an ozone/oxygen mixture flow. A detailed description of an ozone/oxygen controller or sensor system can be found in U.S. patent application Ser. No. 13/271,471, entitled “Systems and Methods for Measuring, Monitoring, and Controlling Ozone Concentration” filed on Oct. 12, 2011, and in U.S. patent application Ser. No. 13/271,449, entitled “Systems and Methods for Measuring, Monitoring, and Controlling Ozone Concentration” filed on Oct. 12, 2011, and which are herein incorporated in reference.

In some embodiments, the present invention discloses a method to control the delivery of an ozone/oxygen mixture having desired concentration and flow rate. In general, it is difficult for an ozone generator to provide both high concentration and low concentration at specific flow rates. For example, a low concentration ozone generator cannot produce ozone output having high concentration. Alternatively, a high concentration ozone generator can generate ozone output having low concentration at a higher flow rate, not at same flow rate as the high ozone concentration flow.

In some embodiments, the present invention discloses a method of diverting a portion of an output flow to achieve an ozone/oxygen mixture having specific concentration and flow rate. For example, to achieve an ozone output having low concentration and low flow rate, a first ozone output having low concentration and high flow rate is produced by an ozone generator, and a portion of the first ozone output is diverted to generate a second ozone output having the desired low concentration and low flow rate.

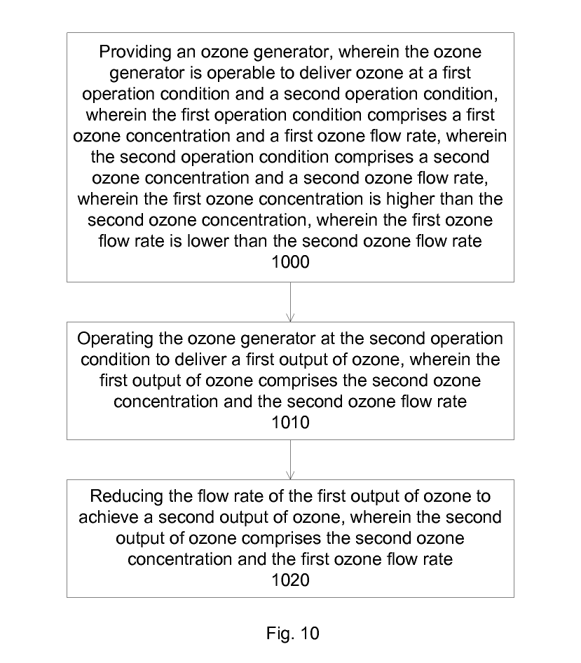

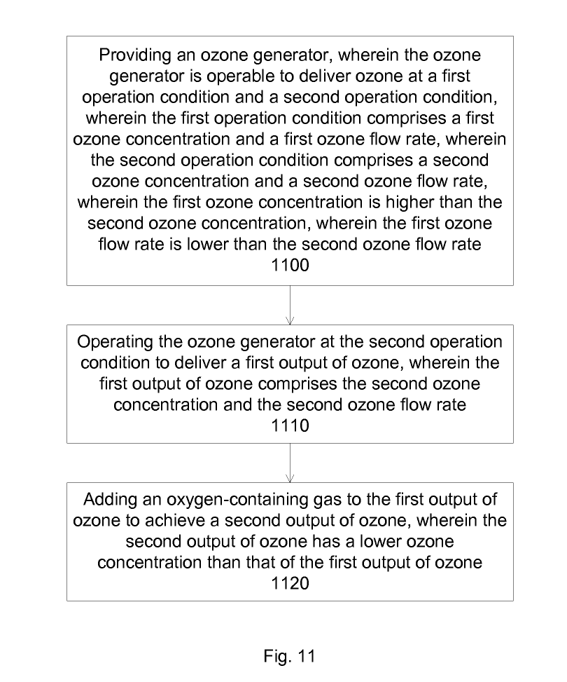

FIG. 10 illustrates an exemplary flowchart for an ozone delivery according to some embodiments of the present invention. Operation 1000 provides an ozone generator. The ozone generator can deliver ozone at multiple operation conditions. For example, a first operation condition comprises a first ozone concentration and a first ozone flow rate. And a second operation condition comprises a second ozone concentration and a second ozone flow rate. In some embodiments, the first ozone concentration is higher than the second ozone concentration, and the first ozone flow rate is lower than the second ozone flow rate. The present method discloses a process for providing an ozone output having the second ozone concentration with the first ozone flow rate.

Operation 1010 operates the ozone generator at the second operation condition to deliver a first output of ozone. Thus the first output of ozone comprises the second ozone concentration and the second ozone flow rate.

Operation 1020 reduces the flow rate of the first output of ozone to achieve a second output of ozone. For example, a portion of the first output of ozone can be diverted to a flow diverter assembly, resulting in the second output of ozone comprising the second ozone concentration and the first ozone flow rate.

In some embodiments, the method further comprises setting a flow rate for the second output of ozone. For example, the flow rate of the second output of ozone is set by a mass flow controller, either to the output flow, to the diverted flow, or to both flows.

In some embodiments, reducing the flow rate comprises diverting a third flow from the first output of ozone, wherein the third flow equals to the difference between the first and second outputs of ozone. The first ozone concentration is higher than 15 wt %, and the second ozone concentration is lower than 5 wt %. The first ozone flow rate is lower than 300 sccm, and the second ozone flow rate is higher than 300 sccm.

In some embodiments, the present invention discloses a method of diluting an output flow to achieve an ozone/oxygen mixture having specific concentration and flow rate. For example, to achieve an ozone output having low concentration and high flow rate, a first ozone output having high concentration and low flow rate is produced by an ozone generator, and an additional oxygen is added to the first ozone output to generate a second ozone output having the desired low concentration and high flow rate.

FIG. 11 illustrates another exemplary flowchart for an ozone delivery according to some embodiments of the present invention. Operation 1100 provides an ozone generator. The ozone generator can deliver ozone at multiple operation conditions. For example, a first operation condition comprises a first ozone concentration and a first ozone flow rate. And a second operation condition comprises a second ozone concentration and a second ozone flow rate. In some embodiments, the first ozone concentration is higher than the second ozone concentration, and the first ozone flow rate is lower than the second ozone flow rate. The present method discloses a process for providing an ozone output having concentration lower than that of the second ozone concentration with a flow rate higher than that of the second ozone flow rate.

Operation 1110 operates the ozone generator at the second operation condition to deliver a first output of ozone. Thus the first output of ozone comprises the second ozone concentration and the second ozone flow rate. Alternatively, the ozone generator can be operated at the first operation condition, or in any operation condition between the first and second operations.

Operation 1120 adds an oxygen-containing gas to the first output of ozone to achieve a second output of ozone. For example, an oxygen gas can be added to the first output of ozone, resulting in the second output of ozone having lower ozone concentration with higher flow rate.

In some embodiments, the present invention discloses a method of diluting and diverting a portion of an output flow to achieve an ozone/oxygen mixture having specific concentration and flow rate. For example, to achieve an ozone output having low concentration and low flow rate, a first ozone output having high concentration and low flow rate is produced by an ozone generator, and an additional oxygen is added to the first ozone output to generate a second ozone output having low concentration and high flow rate. Then a portion of the second ozone output is diverted to generate a third ozone output having the desired low concentration and low flow rate.

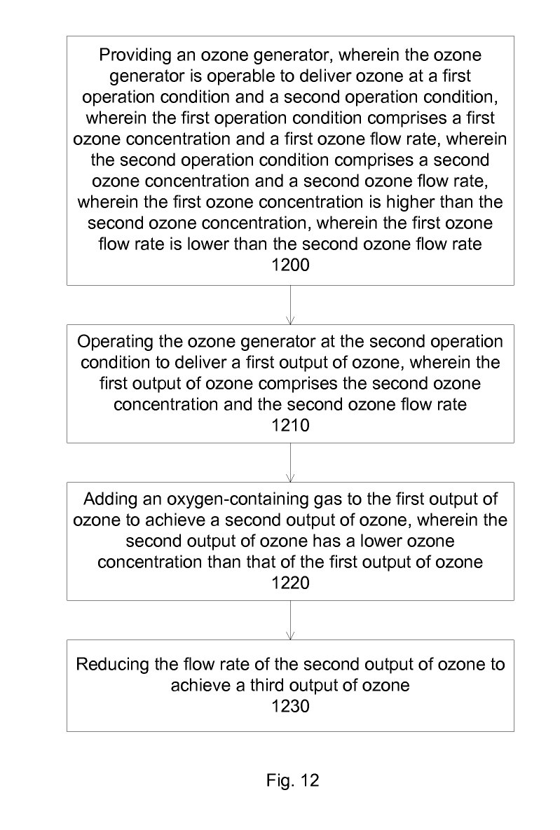

FIG. 12 illustrates an exemplary flowchart for an ozone delivery according to some embodiments of the present invention. Operation 1200 provides an ozone generator. The ozone generator can deliver ozone at multiple operation conditions. For example, a first operation condition comprises a first ozone concentration and a first ozone flow rate. And a second operation condition comprises a second ozone concentration and a second ozone flow rate. In some embodiments, the first ozone concentration is higher than the second ozone concentration, and the first ozone flow rate is lower than the second ozone flow rate. The present method discloses a process for providing an ozone output having concentration lower than that of the second ozone concentration with a flow rate lower than that of the second ozone flow rate.

Operation 1210 operates the ozone generator at the second operation condition to deliver a first output of ozone. Thus the first output of ozone comprises the second ozone concentration and the second ozone flow rate. Alternatively, the ozone generator can be operated at the first operation condition, or in any operation condition between the first and second operations.

Operation 1220 adds an oxygen-containing gas to the first output of ozone to achieve a second output of ozone. For example, an oxygen gas can be added to the first output of ozone, resulting in the second output of ozone having lower ozone concentration with higher flow rate.

Operation 1230 reduces the flow rate of the second output of ozone to achieve a third output of ozone. For example, a portion of the second output of ozone can be diverted to a flow diverter assembly, resulting in the third output of ozone comprising the desired concentration and flow rate.

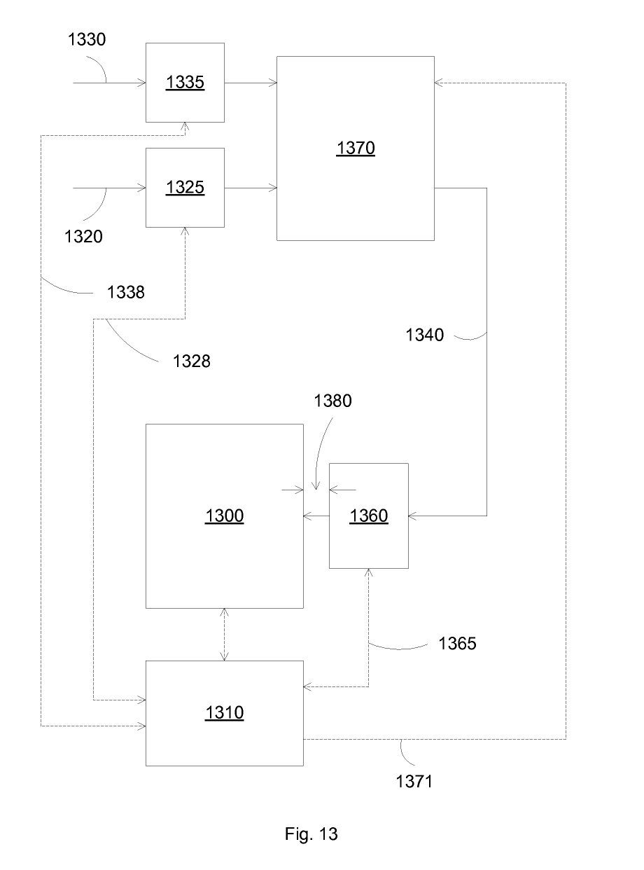

FIG. 13 illustrates an exemplary configuration for a process chamber utilizing an ozone delivery system according to some embodiments of the present invention. A process chamber 1300 is controlled by a system controller 1310, for example, to heat a substrate support, to transfer substrates in and out of the process chamber, or to control process gases and pressure in the process chamber. An ozone generator 1370 accepts an oxygen input flow 1320 and a nitrogen input flow 1330, and outputs an ozone mixture 1340 (e.g., a mixture of oxygen, ozone and nitrogen) to the process chamber. The controller can output a power signal 1371 to the ozone generator 1370 to regulate the ozone concentration. The system controller 1310 can control the flow rates of oxygen and nitrogen, through outputs 1328 and 1338 to the flow controller 1325 and 1335, respectively. A flow diverter/dilution assembly 1360 is positioned in the path of the ozone mixture 1340, in the vicinity of the process chamber. The distance 1380 between the flow diverter/dilution assembly 1360 and the process chamber 1300 is preferably short to provide point of use measurement and controlling. Typically, the distance 1380 is preferably less than 1 m, and more preferably less than 10 cm from the process chamber. The controller can output a control signal 1365 to the flow diverter/dilution assembly 1360 to regulate the ozone concentration and flow rate to be provided to the chamber 1300.

In some embodiments, the present invention discloses a processing system comprising a process chamber; an ozone generator, wherein the ozone generator comprises a first outlet, wherein the ozone generator is operable to deliver ozone at a first operation condition and a second operation condition, wherein the first operation condition comprises a first ozone concentration and a first ozone flow rate, wherein the second operation condition comprises a second ozone concentration and a second ozone flow rate, wherein the first ozone concentration is higher than the second ozone concentration, wherein the first ozone flow rate is lower than the second ozone flow rate; a flow controller disposed in close proximity to the process chamber, wherein the flow controller comprises an inlet for accepting a first flow and a second outlet for outputting a second flow, wherein the inlet is in fluid contact with the outlet of the ozone generator, wherein the second outlet is in fluid contact with the process chamber, wherein the flow controller is operable to control the flow rate of the second flow to be lower than the flow rate of the first flow; and a flow assembly in fluid contact with the first outlet of the ozone generator, wherein the flow assembly comprises a controllable diversion path for accepting the difference between the first flow and the second flow.

In some embodiments, the flow assembly is disposed in close proximity with the ozone generator. The first ozone concentration is higher than 15 wt %, and the second ozone concentration is lower than 5 wt %. The first ozone flow rate is lower than 300 sccm, and the second ozone flow rate is higher than 300 sccm.

In some embodiments, the flow further comprise a circuit controller for controlling at least one of the flow controller, the flow assembly, a power of the ozone generator and an oxygen flow rate of the ozone generator.

Although the foregoing examples have been described in some detail for purposes of clarity of understanding, the invention is not limited to the details provided. There are many alternative ways of implementing the invention. The disclosed examples are illustrative and not restrictive.

What is claimed is:

1. A method comprising:
providing an ozone generator,
wherein the ozone generator is operable to deliver ozone at a first operation condition, wherein the first operation condition comprises a first ozone concentration and a first ozone flow rate,
wherein the ozone generator is further operable to deliver ozone at a second operation condition, wherein the second operation condition comprises a second ozone concentration and a second ozone flow rate,
wherein the first ozone concentration is higher than the second ozone concentration, and wherein the first ozone flow rate is lower than the second ozone flow rate;
operating the ozone generator at the second operation condition to deliver a first output of ozone;
diverting a portion of the first output to provide a second output;
coupling the second output to a process chamber.

2. The method of claim 1 further comprising
setting a flow rate for the second output of ozone.

3. The method of claim 1, wherein reducing the flow rate comprises diverting a third flow from the first output of ozone, wherein the third flow equals the difference between the first and second outputs of ozone.

4. The method of claim 1, wherein the first ozone concentration is higher than 15 wt %, and the second ozone concentration is lower than 5 wt %.

5. The method of claim 1, wherein the first ozone flow rate is lower than 300 sccm, and the second ozone flow rate is higher than 300 sccm.

6. An ozone delivery system comprising:
an ozone generator,
wherein the ozone generator comprises a first outlet,
wherein the ozone generator is operable to deliver ozone at a first operation condition, wherein the first operation condition comprises a first ozone concentration and a first ozone flow rate,
wherein the ozone generator is further operable to deliver ozone at a second operation condition, wherein the second operation condition comprises a second ozone concentration and a second ozone flow rate,
wherein the first ozone concentration is higher than the second ozone concentration, and wherein the first ozone flow rate is lower than the second ozone flow rate;
a flow controller in fluid contact with the first outlet of the ozone generator,
wherein the flow controller comprises an inlet for accepting a first flow and a second outlet for delivering a second flow,
wherein the inlet is in fluid contact with the first outlet of the ozone generator,
wherein the flow controller is operable to control the flow rate of the second flow to be lower than the flow rate of the first flow;
a flow assembly in fluid contact with the first outlet of the ozone generator, wherein the flow assembly comprises a controllable diversion path for accepting the difference between the first flow and the second flow.

7. The system of claim 6, wherein the flow controller comprises a mass flow controller configured for controlling a mixture of oxygen/ozone.

8. The system of claim 6, wherein the flow controller comprises a mass flow controller configured for controlling an oxygen flow with a conversion factor suitable for the concentration of a mixture of oxygen/ozone.

9. The system of claim 6, wherein the flow assembly comprises one or more conduits of fixed orifice.

10. The system of claim 6, wherein the flow assembly comprises a conduit with controllable orifice.

11. The system of claim 6, wherein the flow assembly comprises a mass flow controller.

12. The system of claim 6, wherein the flow assembly comprises a storage volume with a relief valve.

13. The system of claim 6 further comprising a circuit controller for controlling at least one of the flow controller, the flow assembly, a power of the ozone generator, and an oxygen flow rate of the ozone generator.

14. The system of claim 6 further comprising a second circuit controller controlling the flow assembly.

15. The system of claim 6, wherein the first ozone concentration is higher than 15 wt %, and the second ozone concentration is lower than 5 wt %.

16. A processing system comprising:
a process chamber;
an ozone generator, wherein the ozone generator comprises a first outlet, wherein the ozone generator is operable to deliver ozone at a first operation condition and a second operation condition, wherein the first operation condition comprises a first ozone concentration and a first ozone flow rate, wherein the second operation condition comprises a second ozone concentration and a second ozone flow rate, wherein the first ozone concentration is higher than the second ozone concentration, wherein the first ozone flow rate is lower than the second ozone flow rate;
a flow controller disposed in close proximity to the process chamber, wherein the flow controller comprises an inlet for accepting a first flow and a second outlet for outputting a second flow, wherein the inlet is in fluid contact with the outlet of the ozone generator, wherein the second outlet is in fluid contact with the process chamber, wherein the flow controller is operable to control the flow rate of the second flow to be lower than the flow rate of the first flow;
a flow assembly in fluid contact with the first outlet of the ozone generator, wherein the flow assembly comprises a controllable diversion path for accepting the difference between the first flow and the second flow.

17. The system of claim 16, wherein the flow assembly is disposed in close proximity with the ozone generator.

18. The system of claim 16 further comprising a circuit controller for controlling at least one of the flow controller, the flow assembly, a power of the ozone generator and an oxygen flow rate of the ozone generator.

19. The system of claim 16, wherein the first ozone concentration is higher than 15 wt %, and the second ozone concentration is lower than 5 wt %.

20. The system of claim 16, wherein the first ozone flow rate is lower than 300 sccm, and the second ozone flow rate is higher than 300 sccm.
